(19) United States
(12) Patent Application Publication
(10) Pub. No.: US 2019/0054791 A1
(43) Pub. Date: Feb. 21, 2019

(54) MODIFIED SHOCK ABSORBER FOR TILTABLE VEHICLES

(71) Applicant: Ricardo Jesús RIVAS SÁNCHEZ, Mexico City (MX)

(72) Inventor: Ricardo Jesús RIVAS SÁNCHEZ, Mexico City (MX)

(21) Appl. No.: 16/101,773

(22) Filed: Aug. 13, 2018

(30) Foreign Application Priority Data
Aug. 17, 2017 (MX) MX/U/2017/000359

(51) Int. Cl. B60G 17/015; B60G 17/016; B60G 21/00

(52) U.S. Cl. CPC B60G 17/0155; B62D 9/02; B60G 21/007; B60G 17/0162

(57) ABSTRACT

A modified shock absorber for tiltable vehicles, with means to maintain the vertical of the vehicle without offering resistance to the extension movements during tilting maneuvers.

### FIELD OF THE INVENTION

The present invention relates to a shock absorber for tiltable vehicles and, more particularly to a novel modified actuator for tiltable vehicles, adapted to allow the free inclination of the suspension without offering extension resistance in part of its travel.

### BACKGROUND OF THE INVENTION

The manned tiltable vehicles are utilitarian and recreational vehicles that provide a sporty driving sensation, which is achieved through the special character of its driving system, which inclines the chassis together with the inclination plane of its wheels, in order to allow the vehicle rotation at the same time that its gravity center is modified. This peculiar type of driving allows to take curves more tightly and at a higher speed than with other types of vehicles. To achieve the above, the chassis of the vehicle is modified to allow the free inclination of the tread plane of its tires, which requires extensive modifications to the power transmission and suspension system.

The suspension of this type of vehicle differs significantly with respect to that used in the conventional chassis of four-wheel motor vehicles, since in these vehicles, the chassis is inclined with respect to the plane formed by the road surface, so that the shock absorber mechanisms are out of phase with their normal operating position, which causes the latter to be subjected to compression and/or extension forces greater than those that would be subjected to being placed in a rigid frame of reference. Likewise, this type of vehicles need annexed mechanisms to maintain actively the vertical, since due to the arrangement of the mechanical elements that allow its inclination, the chassis does not have a fixed rest position, due to the lack of a rigid support frame. Therefore, the tiltable vehicles use shock absorbers that apply an active resistance to maintain the chassis in a neutral position that can only be modified by applying an effort provided by the vehicle driving mechanism.

Examples of this type of mechanisms for maintaining the vertical of a tiltable vehicle are described in the patent application US 20120181765 A1, which describes a three-wheeled vehicle that uses the inclination of the front wheels to allow the rotation thereof. In this development, the shock absorbers are anchored to a central bar on which the vehicle chassis rests, while a central hydraulic cylinder modifies the vehicle inclination by its extension or compression. In this arrangement, the shock absorbers do not intervene in any way with the tilting mechanism and the constant operation of the central hydraulic cylinder is required to keep the vehicle in the vertical, being necessary the inclusion of a hydraulic system in the vehicle to be able to control the driving of the same.

The patent application US 20120232758 A1 describes a 3-wheeled vehicle, which uses the inclination of the rotation plane of the tires to enable the controlled rotation of the vehicle. In this development, the shock absorbers are anchored in each of the suspension arms and are joined in a central support located in a central support bar, in this way the shock absorbers are firmly anchored by their bases and do not require extension mechanisms since the distances between the anchorage points of the shock absorbers, does not change during the inclination. In the aforementioned arrangement the shock absorbers do not actively intervene to maintain the vertical of the vehicle, which is maintained thanks to the steering mechanism, so in case of failure of this, the vehicle would be tilted.

The U.S. Pat. No. 4,546,997 A, describes a three-wheeled tiltable vehicle in which the shock absorbers are anchored to extensions that stretch from the central chassis, said extensions being designed in such a way that they actively rotate on their base to avoid changing the distance with respect to the anchor point of the plate that supports the wheel. However, said shock absorbers do not actively intervene to maintain the vertical of the vehicle which must be maintained by means of the gripping of the steering wheel by the user, so that in case the user stops holding the steering wheel, the vehicle loses the vertical.

The U.S. Pat. No. 6,763,905 B2, describes an impact absorption system for tiltable vehicles with at least one rear wheel and two front steering wheels. In said system the shock absorbers are anchored by their upper part to a tilting structure that allows them to maintain their relative distance with respect to the upper support bars of the tire tilting mechanism. However, in said arrangement the shock absorbers in no way intervene to maintain the vertical of the vehicle, which can only be achieved by blocking the steering mechanism.

The U.S. Pat. No. 7,568,541 B2 protects a control system for tiltable vehicles that allows the automatic return to the vertical position. In this system, an energy storage device that is independent of the electrical and hydraulic systems of the vehicle keeps active the actuators that return the vehicle to the vertical position after each tilting. The described mechanism has two springs that return the vehicle frame to the vertical; however, said springs provide resistance to both compression and extension, so that increases the resistance against the vehicle inclination.

The aforementioned systems, although they allow to maintain to a certain extent the vertical of the vehicle when it is traveling on straight lines, in most cases require an additional control system to keep operating the actuators in charge of returning the vehicle to the vertical, being in many cases necessary the inclusion of alternative energy sources for the control of said actuator system. In addition to the above, the used shock absorber system is independent of the mechanical system responsible for returning the vehicle to the vertical, so it requires modifications to the steering system to prevent the shock absorbers from extending or compressing beyond their work limits, since when tilting the chassis the distances between the anchor points varies significantly.

In view of the above problems, there is a need to provide a modified actuator for tiltable vehicles, which allows to maintain the vertical of the vehicle actively, without offering resistance to the lifting movements with respect to the resting plane of the vehicle, at the same time that resistance problems caused by the change in operating distances of the actuators caused by the inclination of the chassis with respect to the wheel frame are avoided. Also, there is a need to simplify the mechanism of the used actuators in order to dispense with control and power mechanisms additional to those that provide power to the wheels of the vehicle.

### SUMMARY OF THE INVENTION

In order to overcome the disadvantages of presently available actuators and shock absorber systems for tiltable vehicles, the present invention aims to provide a novel modified shock absorber for tiltable vehicles, which offers resistance only when the vehicle tilting mechanism is in the rest position or when one of its sides descends, while during the maneuvers of lifting the chassis said shock absorber does not generate any type of resistance or traction.

A particular objective of the present invention is to provide a modified shock absorber for tiltable vehicles, which does not require additional mechanisms of resistance to maintain the vertical of the vehicle.

Another object of the present invention is to provide a modified shock absorber for tiltable vehicles, which can be used in both three-wheeled and four-wheeled vehicles.

The aforementioned objects, as well as others and the advantages of the present invention, will become apparent from the following detailed description thereof.

### DESCRIPTION OF THE FIGURES OF THE INVENTION

FIG. 1 shows a side cut view of the modified shock absorber (A) of the present invention in its minimum extension position.

FIG. 2 shows a side cut view of the modified shock absorber (A) of the present invention in its neutral position.

FIG. 3 shows a side cut view of the modified shock absorber (A) of the present invention in its maximum extension position.

FIG. 4 shows an inverted tricycle type tiltable vehicle with modified shock absorbers (A) of the present invention in rest position.

FIG. 5 shows an inverted tricycle type tiltable vehicle with modified shock absorbers (A) of the present invention in the inclined position.

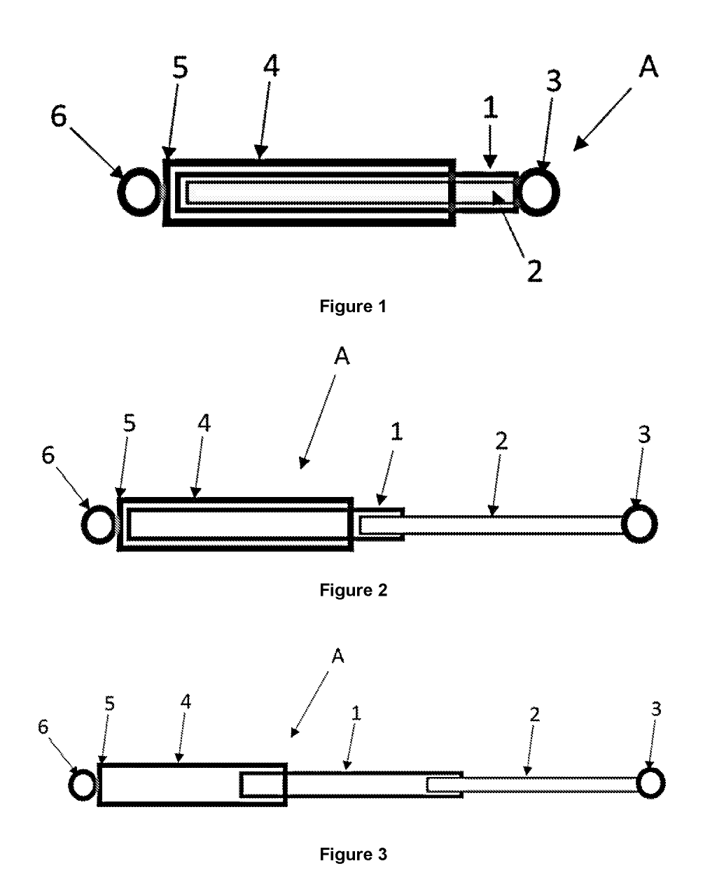

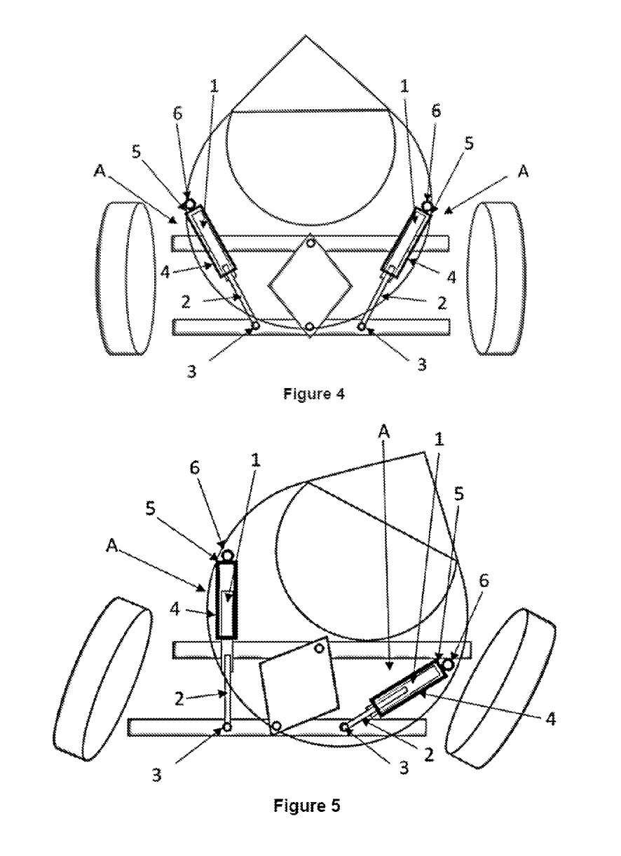

### DETAILED DESCRIPTION OF THE INVENTION

The present invention provides a modified shock absorber for tiltable vehicles, which offers resistance when the vehicle tilting mechanism is in the rest position; while when the chassis is tilted to one side, said actuator only offers resistance to the compression movement having a free travel in its extension movement.

To achieve the above mentioned, the novel shock absorber (A) of the present invention is formed by a central cylinder (1) with internal means to generate resistance to the extension and compression movements, such as a fluid-based shock absorber system, a friction system or a mechanical compression system; an extension rod (2) coupled to said internal resistance generation means, with a terminal end (3) with means suitable for articulately fixing to the chassis upper part of a tiltable vehicle and; a telescopic extension (4) with an internal diameter substantially equal to the external diameter of the central cylinder (1) that allows it to receive inside said central cylinder (1), the telescopic extension (4) having a closed terminal end (5) wherein a terminal rod (6) is arranged with means for its hinged connection with the lower part of the vehicle tilting mechanism. The shock absorber (A) described above, in its rest position, is completely retracted within the telescopic extension (4), so that the lower part of the central cylinder (1) knocks into directly to the closed terminal end (5). In this position, the internal means to generate resistance actively react to the compression efforts, so they dampen any type of vibration caused by the movement of the vehicle. When the vehicle is tilted, the central cylinder (1) of the shock absorber (A), located on the side of the vehicle that is lifted, moves freely along the length of the telescopic extension (4) without generating any resistance to the extension; while the central cylinder (1) of the shock absorber (A) located on the side of the vehicle that descends, remains in constant contact with the terminal end (5) of the telescopic extension, so that it offers compression resistance, which allows the vehicle to return to its resting point.

In one of the embodiments of the present invention, the telescopic extension (4) has at its open end a retainer which prevents the central cylinder (1) from completely exiting the telescopic extension (4).

In a further embodiment of the present invention, the telescopic extension (4) has a pair of internal guides that correspond to a series of extensions formed on the surface of the central cylinder (1), which prevent the walls of the latter from being misaligned with respect to the internal walls of the telescopic extension.

The present invention has been described according to a preferred embodiment; however, it will be apparent to a technician with average knowledge in the art that modifications to the invention may be made, without departing from its spirit and scope.

1. A modified shock absorber (A) for tiltable vehicles comprising a central cylinder (1) with internal means to generate resistance to the extension and compression movements and; an extension rod (2) coupled to said resistance generation means, with a terminal end (3), with means suitable to be hingedly fixed to the chassis upper part of a tiltable vehicle, characterized in that it also comprises a telescopic extension (4) with an internal diameter substantially equal to the external diameter of the central cylinder (1) that allows it to receive inside said central cylinder (1), the telescopic extension (4) having a closed terminal end (5) in which a terminal rod (6) is arranged with means for its hinged connection with the lower part of the vehicle tilting mechanism.

2. The shock absorber according to claim 1, characterized in that the internal means to generate resistance to the extension and compression movements are selected from a shock absorber system based on a fluid, a friction system or a mechanical compression system.

3. The shock absorber according to claim 1, characterized in that the telescopic extension (4) has a pair of internal guides that correspond to a series of extensions formed on the surface of the central cylinder (1).
